(19) United States
(12) Patent Application Publication
(10) Pub. No.: US 2006/0267926 A1
(43) Pub. Date: Nov. 30, 2006

(54) Hidden mouse pad

(76) Inventor: Chia Yung Chen, Taipei City (TW)

Correspondence Address: Chia Yung Chen, 9F., No.37, Dongsing Road, Xinyi District, Taipei City, 110, TW

(21) Appl. No.: 11/138,596

(22) Filed: May 27, 2005

(51) Int. Cl. G09G 5/00

(52) U.S. Cl. 345/156

(57) ABSTRACT

The present invention describes a hidden mouse pad, which includes a containing unit having a slot on one side and a pad disposed in the containing unit and capable of being drawn out from the slot, so that the mouse pad can be stored, kept and accessed easily.

### FIELD OF THE INVENTION

The present invention relates to a hidden mouse pad, and more particularly to a mouse pad that can be stored, kept and accessed easily.

### BACKGROUND OF THE INVENTION

In general, a prior art mouse pad is made of a plastic sheet, and the plastic material could be hard or soft that allows a user to place a mouse on the mouse pad when using a computer, so that the user has better feel and sensitivity of the mouse.

Although the prior art mouse gives better feel and sensitivity of the mouse, the mouse pad is still lad on a desk top when the computer is not in use. Such arrangement reduces the using area of the desk top. If a user wants to store the mouse, the mouse usually cannot be rolled or folded because of its fixed volume. Therefore, a prior art cannot meet the requirements of practical use.

### SUMMARY OF THE INVENTION

It is a primary objective of the present invention is to make a pad capable of being drawn out from a slot of a containing unit, so that the mouse pad can be stored, keep and accessed easily.

To achieve the foregoing objective, a hidden mouse pad of the present invention comprises a containing unit having a slot on one side and a pad disposed in the containing unit and capable of being drawn out from the slot.

### BRIEF DESCRIPTION OF THE DRAWINGS

FIG. 1 is an exploded view of the present invention;

FIG. 2 is a perspective view of the present invention;

FIG. 3 is a schematic view of a mouse pad being pulled out according to the present invention;

FIG. 4 is a schematic view of an application of the present invention;

FIG. 5 is a schematic view of a mouse being rolled in according to the present invention; and

FIG. 6 is a schematic view of another application of the present invention.

### DETAILED DESCRIPTION OF THE PREFERRED EMBODIMENTS

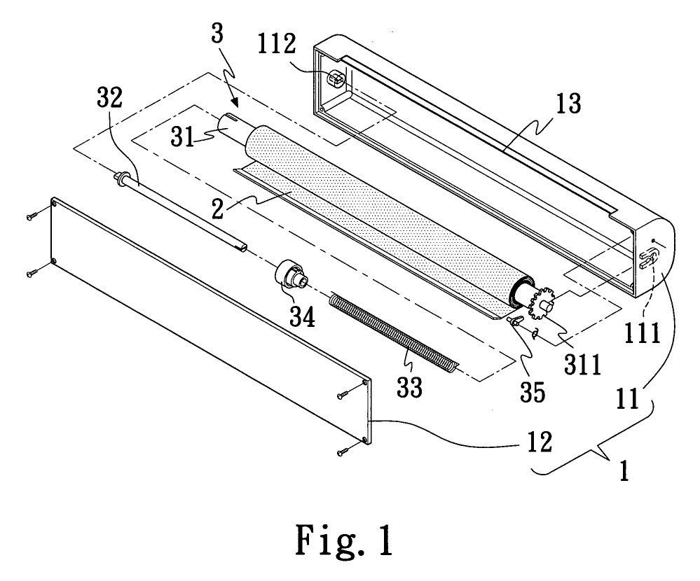

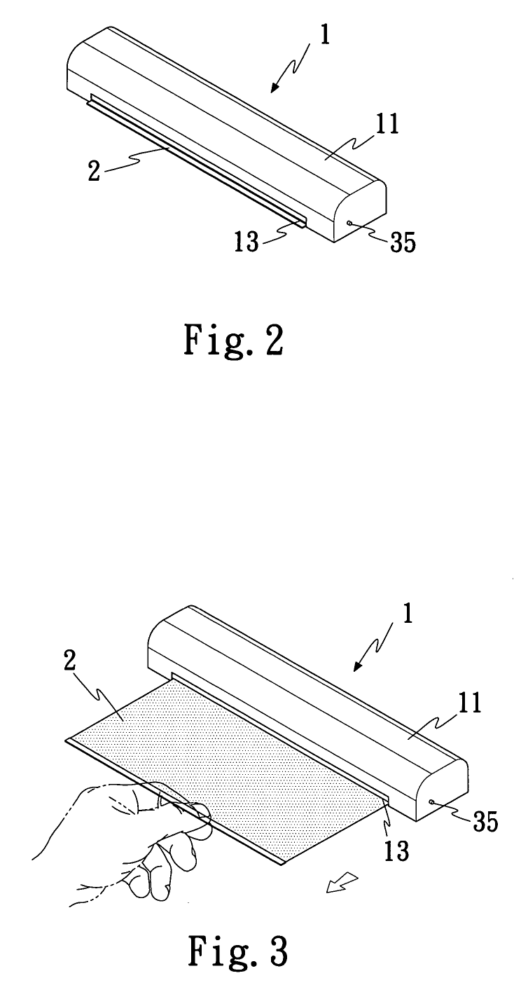

Referring to FIGS. 1 and 2, an exploded view and a perspective view of the present invention are illustrated respectively. In the figures, a hidden mouse pad in accordance with the invention comprises a containing unit 1 and a pad 2 to achieve the effect of storing, keeping and accessing the mouse pad easily.

The containing unit 1 has a slot 13 on one side, and the containing unit 1 is comprised of a housing 11 and a cover panel 12 being covered onto the housing 11. A connecting section 111, 112 is disposed separately on two corresponding opposite sides in the housing 11 of the containing unit 1 and a coiling mechanism 3 is movably installed in the containing unit 1. The coiling mechanism 3 comprises a roller 31 coupled to a pad 2, a shaft 32 sheathed into to the roller 31, a resilient element 32 sheathed into the shaft 32 and coupled to the roller 31, a cover 34 connected between the resilient element 32 and the roller 31, and two connecting sections 111, 112 of the housing pivotally and separately coupled to an end of the roller 31 and an end of the shaft 32. The roller 31 has a gear section 311 disposed at one end. A control button 35 is installed between the gear section 311 of the roller and the housing 11 of the containing unit 1, and one end of the control button 35 is latched onto the gear section 311 of the roller 31, and the other end is exposed from a side of the containing unit 1.

The pad 2 is disposed in the containing unit 1, and one end of the pad 2 can be drawn out from a slot 31 of the containing unit 1, and the other end is connected to a coiling mechanism 3, such that the foregoing structure defines a hidden mouse pad.

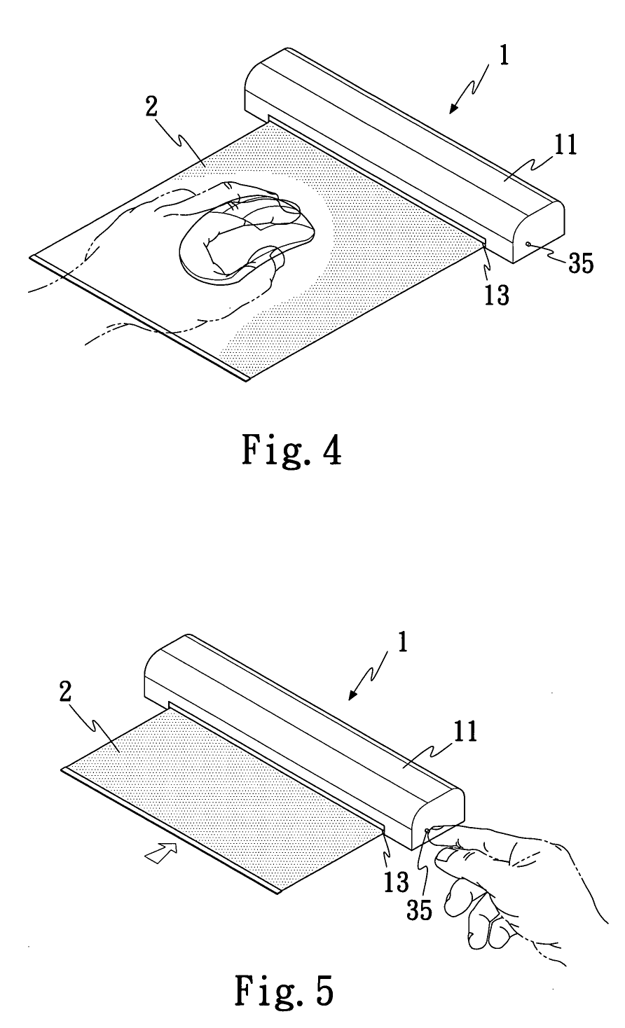

Referring to FIGS. 3, 4 and 5, a schematic view of pulling out a mouse pad, a schematic view of an application and a schematic view of rolling in a mouse pad in accordance with the present invention are illustrated respectively. In the figures, a user pulls the pad 2 out from the slot 13 of the containing unit 1 when using a mouse, and the roller 31 of the coiling mechanism 3 is pulled accordingly, so that a resilient element is driven to a compressed status. In the meantime, the gear section 311 of the roller 31 pokes the control button 35 in the same direction. As soon as the pad 2 is pulled to the desired length, the gear section 311 of the roller 31 is latched by the control button 35 in an opposite direction, such that the pad 2 is moved out to a predetermined length as shown in FIG. 3, and then the user can place a mouse on the pad 2 for the use of the mouse as shown in FIG. 4.

If a user wants to roll the pad 2 into the containing unit 1, the user just needs to press the control button 35 to remove the control button 35 from the gear section 311 of the roller 31. In the meantime, the resilient element 32 is released to return to its original status. Then, the roller 31 is rotated accordingly to roll the pad 2 onto the roller 31 in the containing unit 1 as shown in FIG. 5, so as to achieve the effect of storing, keeping and accessing the pad 2 easily.

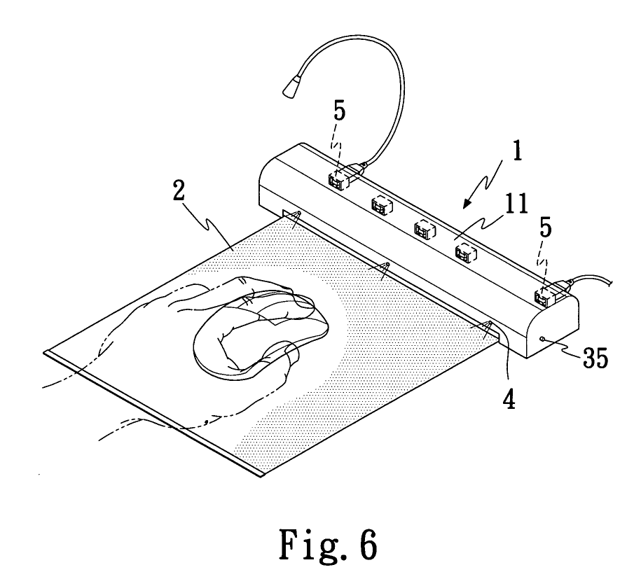

Referring to FIG. 6, another application of the present invention is illustrated. In FIG. 6, the present invention further comprises a plurality of luminous members 4 on the containing unit 1, and the containing unit 1 contains a plurality of USB ports 5 for the signal connection with the computer system. One of the USB ports 5 is electrically coupled to the plurality of luminous members 4 for supplying the power of the computer system to the plurality of luminous members 4.

In summation of the above description, the design of the hidden mouse pad in accordance with the present invention enhances the performance over the conventional structure and achieves the effect of storing, keeping and accessing the mouse pad easily and further complies with the patent application requirements and is submitted to the Patent and Trademark Office for review and granting of the commensurate patent rights.

What is claimed is:

1. A hidden mouse pad, comprising:
a containing unit, having a slot on one side; and
a pad, disposed in said containing unit and one end of said pad capable of being drawn out from said slot of said containing unit.

2. The hidden mouse pad of claim 1, wherein said containing unit is comprised of a housing and a cover panel covered onto said housing.

3. The hidden mouse pad of claim 1, wherein said containing unit has a connecting section disposed separately on two corresponding sides in said containing unit.

4. The hidden mouse pad of claim 1, wherein said containing unit comprises a coiling mechanism movably coupled to an end of said pad.

5. The hidden mouse pad of claim 1, wherein said coiling mechanism comprises a roller coupled to said pad, a shaft sheathed into said roller, and a resilient element sheathed into said shaft and coupled to said roller, and said roller has a gear section at one end, and a control button is installed between said gear section of said roller and said containing unit.

6. The hidden mouse pad of claim 1, wherein said containing unit installs a plurality of luminous members thereon, and said containing unit installs a plurality of USB ports, and said one USB port is electrically coupled to said plurality of luminous members for supplying the power of a computer system to said plurality of luminous members.
